(19) United States
(12) Patent Application Publication
(10) Pub. No.: US 2016/0013687 A1
(43) Pub. Date: Jan. 14, 2016

(54) ELECTRICAL CORE ELEMENT FOR A GENERATOR

(71) Applicant: Davian A. Samuels, Long Beach, CA (US)

(72) Inventor: Davian A. Samuels, Long Beach, CA (US)

(73) Assignee: NEBULA ENERGY INC., Bloomfield, CT (US)

(21) Appl. No.: 14/859,813

(22) Filed: Sep. 21, 2015

Related U.S. Application Data
(63) Continuation of application No. 13/854,608, filed on Apr. 1, 2013, now abandoned.
(60) Provisional application No. 61/618,537, filed on Mar. 30, 2012.

(51) Int. Cl. H02K 1/22; H02K 1/02

(52) U.S. Cl. CPC H02K 1/223; H02K 1/02

(57) ABSTRACT

Permanent magnet electric generators and methods of generating electrical energy are provided. The generators include two rack assemblies each including concentric circular cylindrical cores having circular arrangements of permanent magnets and electrical conductors. The two rack assemblies are axially engaged wherein magnets of the concentric circular cylindrical cores repel adjacent magnets and thereby rotate the cylindrical cores. The rotation of the adjacent magnets in the cores induces an electric current within the electrical conductors, which can be extracted and used in a broad range of applications. Various mechanisms adapted to engage and disengage the two rack assemblies are provided, including the introduction of a vacuum into the generator housing. Methods of generating electrical energy and electrical cores having permanent magnets and conductors are also disclosed.

### CROSS-REFERENCE TO RELATED APPLICATIONS

This application claims priority from pending U.S. Provisional Patent Application 61/618,537, filed on Mar. 30, 2012, the disclosure of which is included by reference herein in its entirety.

### BACKGROUND OF THE INVENTION

1. Technical Field

The present invention generally relates to electrical energy generation by employing the repulsive force of magnets. More particularly, the present invention relates to devise and method for generating electrical energy through the repulsive forces of permanent magnets arranged in multiple circular arrays of cooperating to generate electrical current in conductors positioned within the circular arrays of permanent magnets.

2. Description of Related Art

Alternative sources of energy, specifically alternative source of electric power, have long been sought in attempts to address the ever increasing demand for power and the ever diminishing supply of fossil fuels. One potential source of electric power that has been investigated by others includes the use of the repulsive forces of magnets to generate electrical energy. One result of these investigations is the known as the “Searl Effect Generator.” Invented in the 1940s, the Searle Effect Generator employs magnets to generate electric current, but has achieved limited acceptance in the art. Another attempt to generate electrical energy using magnets is represented what is know as the “Perendev motor,” which also has achieved limited acceptance the art.

In response to this need, the present invention was conceived and developed. The present invention overcomes the limitations of the prior art and provides electrical generators and methods for generating electrical energy.

### SUMMARY OF THE INVENTION

Aspects of the present invention provide sustainable sources of electric power, for example, for vehicles, robotics, mobile devices, and electronics, among other uses. According to aspects of the invention, the repulsive forces of magnets, in particular, of permanent magnets, are used to rotate magnets and conductive coils to induce electric current. The magnets and conductive coils are positioned and oriented within rotatable cylinders, or “cores,” to enhance the generation and extraction of electric current.

One embodiment of the invention is a permanent-magnet electric generator comprising or including a first rack assembly comprising a plurality of first concentric circular cylindrical cores, each of the plurality of the first circular cylindrical cores mounted for rotation and comprising or including a plurality of circular arrangements of permanent magnets, the plurality of circular arrangements of permanent magnets spaced at a plurality of elevations within each first circular cylindrical core; and a plurality of electrical conductors, each of the plurality of conductors positioned about at least some of the plurality of the permanent magnets of the curricular arrangement of permanent magnets; a second rack assembly comprising a plurality of second concentric circular cylindrical cores, each of the plurality of the second circular cylindrical cores radially spaced from each of the plurality of the first circular cylindrical cores and comprising or including a plurality of circular arrangements of permanent magnets, the plurality of circular arrangements of permanent magnets spaced at a plurality of elevations within each second circular cylindrical core; and a plurality of electrical conductors, each of the plurality of conductors positioned about at least some of the plurality of the permanent magnets of the curricular arrangement of permanent magnets; and means for axially engaging the plurality of first concentric circular cylindrical cores of the first rack assembly with the plurality of second concentric circular cylindrical cores of the second rack assembly, wherein at least some of the permanent magnets of the plurality of first circular cylindrical cores of the first rack assembly are repelled by at least some of the permanent magnets of the plurality of second circular cylindrical cores of the second rack assembly wherein each of the first circular cylindrical cores is rotated and an electric current is generated within the plurality of electrical conductors in each of the first circular cylindrical cores and an electric current is generated within the plurality of electrical conductors in each of the second circular cylindrical cores.

In one aspect, the permanent magnets of the plurality of circular arrangements of first rack assembly and the permanent magnets of the plurality of circular arrangements of second rack assembly comprise spherical permanent magnets. In another aspect, the permanent magnets of the plurality of circular arrangements of first rack assembly and the permanent magnets of the plurality of circular arrangements of second rack assembly comprise rare-earth permanent magnets.

In another aspect, the plurality of first concentric circular cylindrical cores of the first rack assembly and the plurality of second concentric circular cylindrical cores of the second rack assembly each comprise at least three concentric circular cylindrical cores. In another aspect, the plurality of elevations within each first circular cylindrical core and the plurality of elevations within each second circular cylindrical core comprise at least three elevations.

In another aspect, the plurality of first concentric circular cylindrical cores and the plurality of second concentric circular cylindrical cores each comprise electrically conductive bearings, and wherein the plurality of electrical conductors in each of the first circular cylindrical cores and the plurality of electrical conductors in each of the second circular cylindrical cores are in electrical communication with the electrically conductive bearings. For example, in another aspect, the electrical generator further comprises an upper bearing rack adapted to engage the electrically conductive bearings, and a lower bearing rack adapted to engage the electrically conductive bearings.

In a further aspect, the electric generator further comprises a housing enclosing the first rack assembly and the second rack assembly. The housing may comprise a top enclosure and a bottom enclosure and a top enclosure, the bottom enclosure and the top enclosure may be adapted for relative translation.

In another aspect, the electric generator may further comprise a vacuum pump adapted to generate a sub-atmospheric pressure within the housing.

Another embodiment of the invention is a method of producing electrical energy comprising or including: providing a first rack assembly comprising a plurality of first concentric circular cylindrical cores, each of the plurality of the first circular cylindrical cores mounted for rotation and comprising or including a plurality of circular arrangements of permanent magnets, the plurality of circular arrangements of permanent magnets spaced at a plurality of elevations within each first circular cylindrical core; and a plurality of electrical conductors, each of the plurality of conductors positioned about at least some of the plurality of the permanent magnets of the curricular arrangement of permanent magnets; providing a second rack assembly comprising a plurality of second concentric circular cylindrical cores, each of the plurality of the second circular cylindrical cores radially spaced from each of the plurality of the first circular cylindrical cores and comprising or including: a plurality of circular arrangements of permanent magnets, the plurality of circular arrangements of permanent magnets spaced at a plurality of elevations within each second circular cylindrical core; and a plurality of electrical conductors, each of the plurality of conductors positioned about at least some of the plurality of the permanent magnets of the curricular arrangement of permanent magnets; and axially engaging the plurality of first concentric circular cylindrical cores of the first rack assembly with the plurality of second concentric circular cylindrical cores of the second rack assembly, wherein at least some of the permanent magnets of the plurality of first circular cylindrical cores of the first rack assembly are repelled by at least some of the permanent magnets of the plurality of second circular cylindrical cores of the second rack assembly wherein each of the first circular cylindrical cores is rotated and an electric current is generated within the plurality of electrical conductors in each of the first circular cylindrical cores and an electric current is generated within the plurality of electrical conductors in each of the second circular cylindrical cores.

In one aspect, the method may further comprise or include positioning the first rack assembly into a top enclosure and positioning the second rack assembly into a bottom enclosure, the bottom and top enclosures relatively translatable and wherein axially engaging the plurality of first concentric circular cylindrical cores of the first rack assembly with the plurality of second concentric circular cylindrical cores of the second rack assembly comprises translating the top enclosure relative to the bottom enclosure.

In another aspect, the bottom and top relatively translatable enclosures may include an air tight seal there between; wherein the method further comprises generating a sub-atmospheric pressure within the housing wherein the bottom and top relatively translatable enclosures translate under atmospheric pressure to axially engage the plurality of first concentric circular cylindrical cores with the plurality of second concentric circular cylindrical cores.

A further embodiment of the invention is an electrical core element comprising or including at least one circular arrangement of permanent magnets; a plurality of electrical conductors passing in proximity with at least some of the permanent magnets; and a housing adapted to retain each of the permanent magnets in the arrangement of permanent magnets in a predetermined position. In one aspect, the housing may further be adapted to retain the plurality of electric conductors in a predetermined position. In another aspect, the housing may be further adapted to retain each of the permanent magnets in a predetermined orientation. In one aspect, the predetermined orientation may comprise orienting a pole of each of the permanent magnets radially within the at least one circular arrangement. In another aspect, the at least one circular arrangement of permanent magnets may comprise a plurality of spaced circular arrangements of permanent magnets. For example, in one aspect, the at least one circular arrangement of permanent magnets may comprise at least one circular arrangement of permanent rare-earth magnets.

These and other aspects, features, and advantages of this invention will become apparent from the following detailed description of the various aspects of the invention taken in conjunction with the accompanying drawings

### BRIEF DESCRIPTION OF THE DRAWINGS

The subject matter, which is regarded as the invention, is particularly pointed out and distinctly claimed in the claims at the conclusion of the specification. The foregoing and other objects, features, and advantages of the invention will be readily understood from the following detailed description of aspects of the invention taken in conjunction with the accompanying drawings in which:

FIG. 1 is a schematic diagram of the interaction of two permanent magnets according to an aspect of the invention.

FIG. 2 is a schematic diagram of the interaction of a plurality of permanent magnets shown in FIG. 1 according to an aspect of the invention.

FIG. 3 is a schematic diagram of a plan view of three rings of permanent magnets according to an aspect of the invention.

FIG. 4 is a schematic diagram of an elevation view of two sets of three rings of permanent magnets shown in FIG. 4 according to an aspect of the invention.

FIG. 5 is a schematic diagram of an elevation view of three sets of three rings of permanent magnets shown in FIG. 4 according to an aspect of the invention.

FIG. 6 is an elevation view of three sets of rings of permanent magnets with conductors according to an aspect of the invention.

FIG. 7 is a perspective view of three sets of rings of permanent magnets shown in FIG. 6.

FIG. 8 is a perspective view of a circular core having permanent magnets with conductors according to another aspect of the invention.

FIG. 9 is a perspective view, partially in cross section, of the circular core shown in FIG. 8.

FIG. 10 is a detailed view of the cross section of the core shown in FIG. 9 identified by Detail 10 in FIG. 9.

FIG. 10A is a detailed view of the cross section of the core shown in FIG. 10 identified by Detail 10A in FIG. 10.

FIG. 11 is a detailed view of the cross section of the core shown in FIG. 9 identified by Detail 11 in FIG. 9.

FIG. 11A is a detailed view of the cross section of the core shown in FIG. 11 identified by Detail 11A in FIG. 11.

FIG. 12 is a detailed view of the cross section of the core shown in FIG. 9 identified by Detail 10 in FIG. 9, according to another aspect of the invention.

FIG. 12A is a detailed view of the cross section of the core shown in FIG. 12 identified by Detail 12A in FIG. 12.

FIG. 13 is a detailed view of the cross section of the core shown in FIG. 9 identified by Detail 11 in FIG. 9, according to another aspect of the invention.

FIG. 13A is a detailed view of the cross section of the core shown in FIG. 13 identified by Detail 13A in FIG. 13.

FIG. 13B is an elevation view of the magnet shown in FIGS. 10 through 13A according to aspects of the invention.

FIG. 13C is an exploded view of the magnet shown in FIG. 13B.

FIG. 14 is a perspective view of a core or ring assembly having multiple cores or rings according to one aspect of the invention.

FIG. 15 is an exploded perspective view of the core assembly shown in FIG. 14.

FIG. 16 is a top perspective view of an electric generator encompassing aspects of the present invention, having a core assembly in an “engaged” position.

FIG. 16A is a bottom perspective view of the electric generator shown in FIG. 16, having the core assembly in an “unengaged” position.

FIG. 17 is an exploded perspective view of the generator shown in FIGS. 16 and 16A.

FIG. 18 is an exploded perspective view of the bearing and core assembly shown in FIG. 17.

FIG. 19 is a perspective view of a top bearing rack shown in FIG. 18 according to an aspect of the invention.

FIG. 20 is a perspective view of a lower bearing rack shown in FIG. 18 according to an aspect of the invention.

FIG. 21 is a cross sectional view of a portion of a typical rack core assembly and top bearing rack, prior to engagement, according to one aspect of the invention.

FIG. 22 is a cross sectional view, similar to FIG. 21, of a portion of a typical rack core assembly and top bearing rack, after engagement, according to one aspect of the invention.

### DETAILED DESCRIPTION OF THE INVENTION

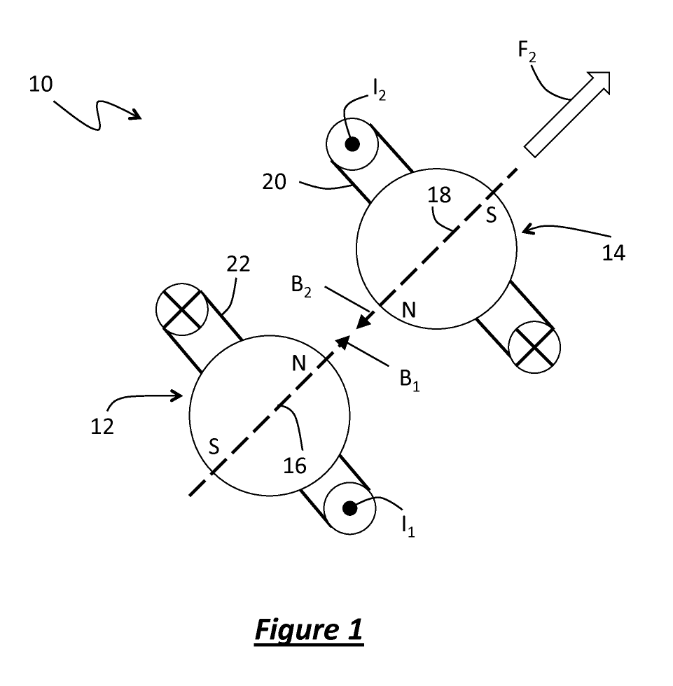

FIG. 1 is a schematic diagram 10 of the interaction of two permanent magnets 12, 14 according to an aspect of the invention. Though according to aspect of the invention permanent magnets 12, 14 may take any convenient shape, in the aspect shown in FIG. 1, magnets 12, 14, are shown as spherical magnets having positive poles, N, and negative poles, S, defining magnetic field vectors B₁ and B₂, respectively, designated by arrows 16 and 18, respectively in FIG. 1. FIG. 1 also includes electrical conductors 20, 22 (for example, copper wires) mounted about magnets 12 and 14 and carrying electrical currents I₁ and I₂, respectively, generated, for example, by the relative movement of magnets 12 and 14 and their respective magnetic fields B₁ and B₂, though for the arrangement shown in FIG. 1, currents I₁ and I₂ may be limited or non-existent for the relative motion of magnets 12 and 14 shown in FIG. 1. As is conventional in the art, the flow of currents I₁ and I₂ through electrical conductors 20 and 22, respectively, is represented by arrow heads (dots) and arrow tails (Xs) in FIG. 1 where current flow in the direction from the arrow tails to the arrow heads.

As shown in FIG. 1, and as is typical of many aspects of the invention disclosed herein, magnets 12 and 14 are arranged whereby similar poles for each magnet 12 and 14 are positioned adjacent to each other. For example, as shown in FIG. 1, the “positive” or N pole of magnet 14 is positioned adjacent to the “positive” or N pole of magnet 12, whereby the “like poles” repel each other. (It will be understood by those in the art, that “positive” or N pole designation is a convention shown for illustrative purposes where the “negative” or S poles of magnets 12 and 14 may be positioned adjacent to each other and provide the “like poles” that repel each other.) In FIG. 1, the electrostatic repulsive force between magnets 12 and 14, for the sake of illustration, is represented by a force F₂ on magnet 14 as magnet 14 is repelled from magnet 12. (It will be understood by those in the art that force F₂ on magnet 14 will be equal and opposite to a repulsive force on magnet 12, but, again, the force F₂ on magnet 14 is shown and used for illustrative purposes.) This repulsive force F₂ and its influence upon magnets, such as, magnet 14, will be a common and recurring phenomenon in aspects of the invention disclosed herein.

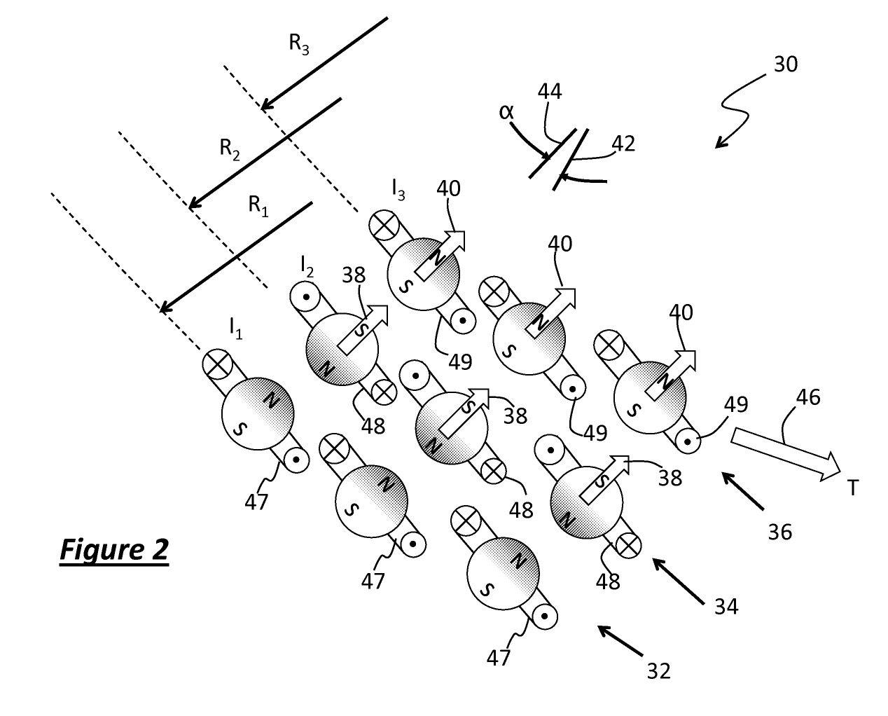

FIG. 2 is a schematic diagram 30 of the interaction of a plurality of permanent magnets similar to magnets 12 and 14 shown in FIG. 1 according to an aspect of the invention. As shown in FIG. 2, three sets of magnets 32, 34, and 36 are positioned on radii R₁, R₂, and R₃, respectively, where R₁>R₂>R₃, in which like poles are positioned adjacent to each other in adjacent sets 32, 34, and 36 of magnets. For example, like positive or N poles are positioned adjacent to magnets in sets 32 and 34, and like negative or S poles lie adjacent in sets 34 and 36. Accordingly, the magnets in set 34 experience repulsive forces 38 due to magnets in set 32, and the magnets in set 36 experience repulsive forces 40 due to magnets in set 34.

As also shown in FIG. 2, the positioning of magnets in sets 32, 34, and 36 is arranged so that the repulsive forces 38 and 40 are directed at an angle α between a radial direction 42 and the direction 44 of forces 38 and 40. Accordingly, according to one aspect of the present invention, the repulsive forces 38 and 40 generate a twist or torque (T), represented by arrow 46 in FIG. 2, upon the collective magnets in sets 34 and 36. The effective of this resulting torque will be discussed further below.

In a fashion similar to the illustration of conductors 20 and 22 in FIG. 1, FIG. 2 illustrates the presence of conductors 47, 48, and 49 about magnets in FIG. 2. According to aspects of the invention, conductors 47 about one or more magnets in set of magnets 32 at radius R₁ may carry a current, I₁, for example, substantially the same current or a different current. Similarly, conductors 48 about one or more magnets in set of magnets 34 at radius R₂ may carry a current, I₂, and conductors 49 about one or more magnet in set of magnets 36 at radius R₃ may carry a current, I₃. Again, the current in conductors 48 may be substantially the same or vary and the current in conductors 49 may be the substantially the same or vary. In one aspect, each of the plurality of conductors 47, 48, or, 49 may comprise a single continuous conductor within each set of magnets 32, 34, and 36, such as, a copper wire, and transmit substantially the same current through each set of magnets 32, 34, and 36 (with account for current losses through the conductor). The currents I₁, I₂, and I₃, may typically vary, but may be substantially the same.

In one aspect, the currents I₁, I₂, I₃, . . . in conductors 47, 48, 49, and those conductors not shown, may be induced by the relative motion of adjacent magnets. For example, the current I₁ may be induced by the movement of the magnets in set of magnets 34 and/or 36 relative to the magnets in set of magnets 32. Also, the current I₂ may be induced by the movement of the magnets in set of magnets 34 and/or 36 relative to the magnets in set of magnets 32. In addition, the current I₃ may be induced by the movement of the magnets in set of magnets 36 and/or magnets in one or more sets of magnets positioned at radii less than R₃ relative to the magnets in set of magnets 32 and/or 34 and/or 36. Other sources of induced current in conductors 47, 48, and 49 due to the relative movement of magnets will be apparent to those of skill in the art.

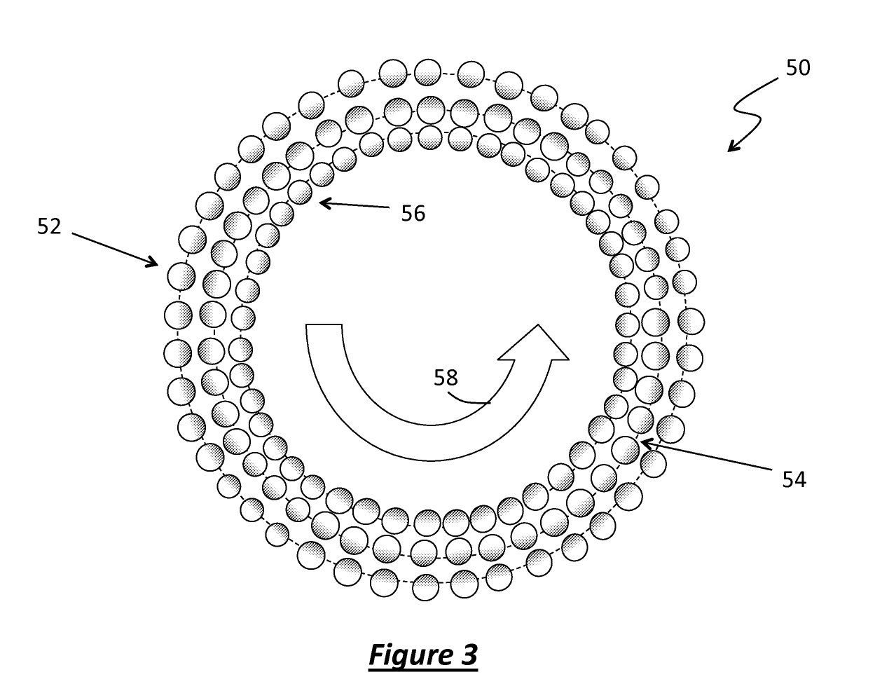

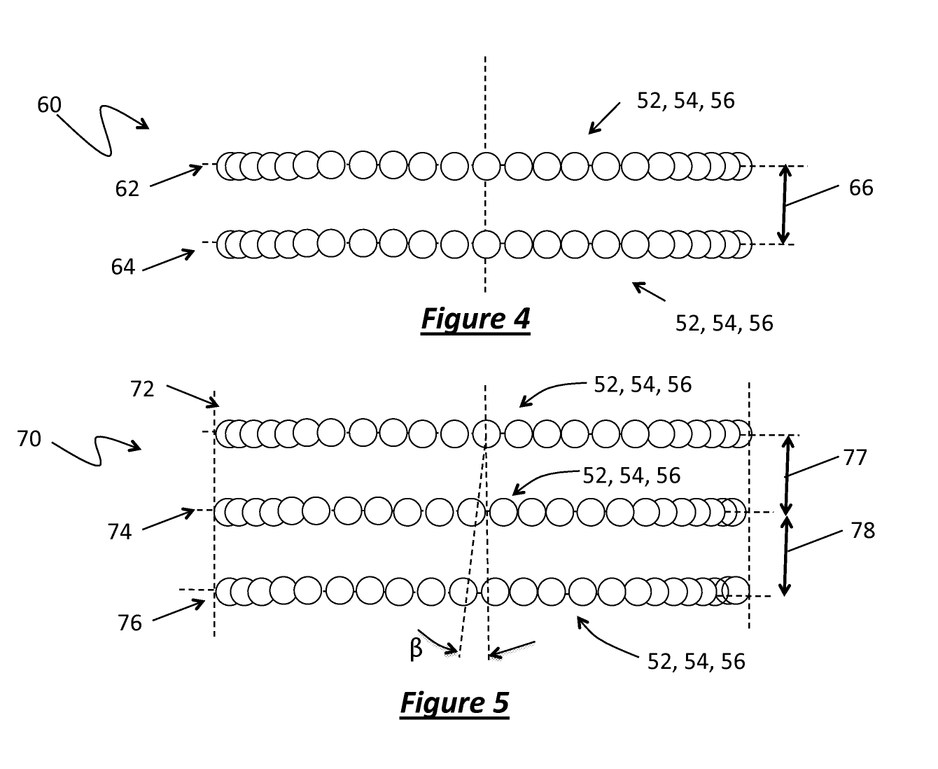

FIG. 3 is a schematic diagram 50 of a plan view of three rings of permanent magnets 52, 54, and 56, similar to magnets 12 and 14 shown in FIG. 1, arranged in a fashion similar to sets of magnets 32, 34, and 36 shown FIG. 2 at varying radii, according to an aspect of the invention. In FIG. 3 and in other figures disclosed herein, like poles of magnets are represented by like shading. For example, the shaded hemispheres of magnets in FIG. 3 represent N (or S) poles of the magnets shown. Conductors similar to conductors 47, 48, and 49 shown in FIG. 2 are omitted for the sake of clarity of illustration in FIG. 3 (and in FIGS. 4 and 5), but are typically present according to aspects of the invention. Again, due to the positioning of the magnets in rings 52, 54, and 56 and the direction of the resulting repulsive forces upon the magnets in rings 52 and 56, a resulting torque, represented by arrow 58, is produced upon the collective magnets in rings 54 and 56.

FIG. 4 is a schematic diagram of an elevation view of an arrangement 60 of two sets 62 and 64 of three rings 52, 54, and 56 of permanent magnets shown in FIG. 3 according to an aspect of the invention. (Again, conductors typically present are omitted in FIG. 4 for clarity.) In this aspect, sets 62 and 64 may typically be spaced, for example, vertically spaced, at a distance 66. According to aspects of the invention, sets 62 and 64 of arrangement 60 may include one or more, or two or more rings, or three or more rings 52, 54, and 56 of magnets.

FIG. 5 is a schematic diagram of an elevation view of an arrangement 70 of three sets 72, 74, and 76 of three rings 52, 54, and 56 of permanent magnets shown in FIG. 3 according to an aspect of the invention. (Again, conductors typically present are omitted in FIG. 5 for clarity.) In this aspect, sets 72, 74, and 76 may typically be spaced, for example, vertically spaced, at distances 77 and 78, distances that may be equal or may vary. Again, according to aspects of the invention, sets 72, 74, and 76 of arrangement 70 may include one or more, two or more, or three or more rings 52, 54, and 56 of magnets. In other aspects, three or more sets 72, 74, and 76 may be provided, for example, four or more sets, six or more sets, or eight or more sets 72, 74, and 76 of magnets may be provided.

It will be apparent to those of skill in the art, that the arrangements 60 and 70 of permanent magnets shown in FIGS. 4 and 5 will typically increase the magnitude of the torque that can be generated according to aspects of the invention, for example, compared to the torque 58 that can be generated by a single set of magnets shown in FIG. 3.

As also shown in FIG. 5, magnets in sets of magnets 72, 74, and 76 in arrangement 70 may be “off set” or vertically off set or misaligned as indicated by the angle β in FIG. 5 between sets 72, 74, and 76. According to this aspect of the invention, the off set angle β may limit or prevent the alignment of magnets in adjacent rings of magnets and limit or prevent the likelihood of magnetic “lock up” between adjacent magnets. According to this aspect, the off setting of magnets helps to ensure that at least some relative motion of magnets and their associated housings is maintained.

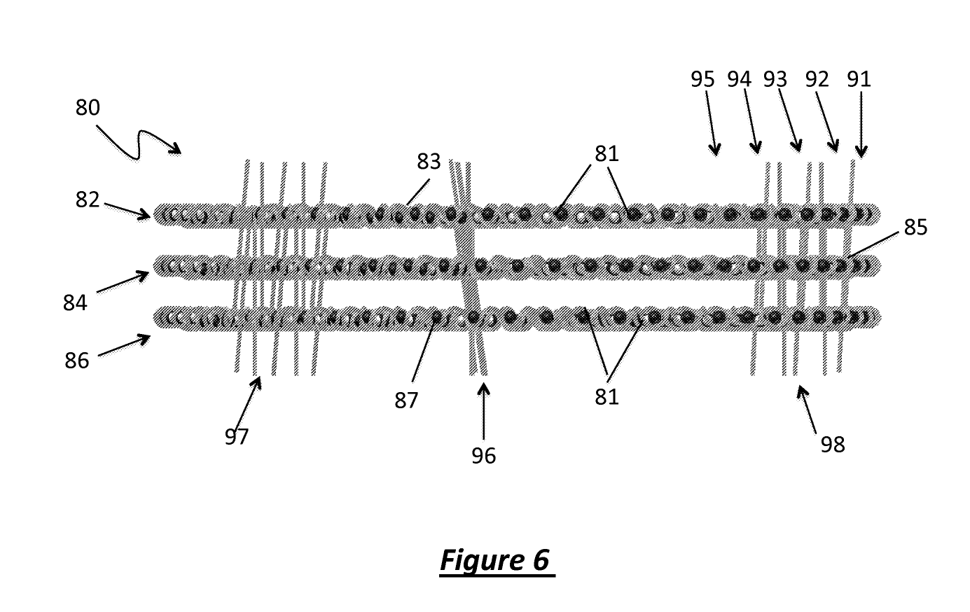

FIG. 6 is a schematic diagram of an elevation view of an arrangement 80 of three sets 82, 84, and 86 of rings 91, 92, 93, 94, and 95 of individual permanent magnets 81, similar to that shown in FIG. 5, according to an aspect of the invention. In the aspect shown in FIG. 6, conductors 83 encircle the magnets in set 82; conductors 85 encircle the magnets in set 84; and conductors 87 encircle the magnets in set 86. Though not shown in FIG. 6, arrangement 80 may typically include one (1) or more, two (2) or more, or three (3) or more rings 91, 92, 93, 94, and 95 of magnets 81 in each set of magnets, 82, 84, and 86, for example, 6 or more rings, or 8 or more rings of magnets 81 positioned at varying radii.

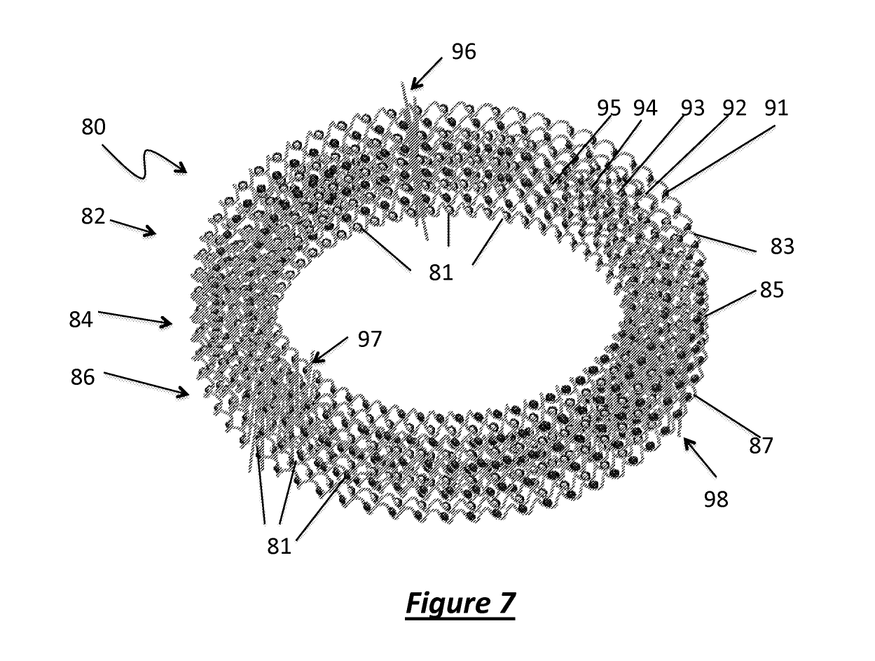

FIG. 7 is a perspective view of the arrangement 80 of the three sets 82, 84, and 86 of rings 91, 92, 93, 94, and 95 of permanent magnets 81 with conductors 83 shown in FIG. 6. Again, in the aspect shown in FIG. 7, conductors 83 encircle the magnets 81 in set 82; conductors 85 encircle the magnets 81 in set 84; and conductors 87 encircle the magnets 81 in set 86. As shown in FIG. 7, in this aspect, each set of rings 82, 84, and 86 in arrangement 80 may include one (1) or more, two (2) or more, or three (3) or more rings 91, 92, 93, 94, and 95 of varying radii of individual magnets 81.

As also shown in FIG. 7, according to aspects of the invention, conductors 83, 85, and 87 about magnets 81 may include one or more continuous conductors, such as, copper wire, that may pass about magnets 81 and lead to external loads or storage. For example, as shown in FIGS. 6 and 7, the current induced in conductors 83,85, and 87 may be carried to output conductors 96, 97, and 98. Output conductors 96, 97, and 98 are typically in electrical communication with other conductors or conductive structures (see the discussion of conductive bearings below) to carry the induced current to external loads or storage (or for re-us). Output conductors 96, 97, and 98, may comprise one or more conductors and may be evenly distributed about rings 91, 92, 93, 94, and 95 of arrangement 80.

According to one aspect of the invention, due to the varying polarity of magnets 81 in arrangement 80, the flow of current induced in conductors 83, 85, and 87 may vary in direction between each ring 91, 92, 93, 94, and 95. According to aspects of the invention, the flow of current in any ring 91-95 may be from the top of the ring to the bottom of the ring or from the bottom of the ring to the top of ring, for example, via output conductors 96, 97, and 98, depending, for example, on the direction of polarity of the magnets in the ring and the relative motion of magnets 81.

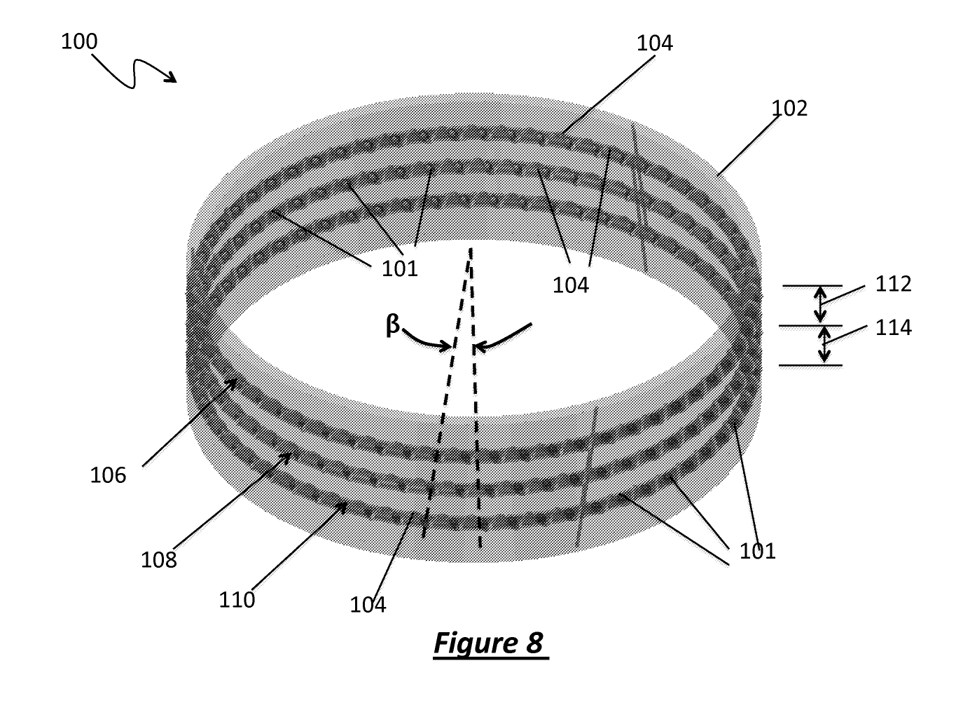

FIG. 8 is a perspective view of a circular cylindrical core 100 having permanent magnets 101 with conductors 104 according to another aspect of the invention. Core 100 is representative of the multiple cores of varying diameter and function that characterize aspects of the present invention. As shown in FIG. 8, core 100 includes a housing or retainer 102 adapted to retain magnets 101 and conductors 104. In one aspect, housing or retainer 102 may also be adapted to orient magnets 101 in predetermined orientation, for example, with a pole of magnets 101 directed radially at an angle offset from a truly radial direction (that is, in a direction substantially directed toward the theoretical center of the circle defined by the circular arrangement 106, 108, or 110 of magnets 101). In the rendering of housing 102 shown in FIG. 8, housing 102 is shown somewhat transparent to assist in illustrating aspects of the invention.

As shown in FIG. 8, permanent magnets 101 may typically be arranged in spaced circular arrangements 106, 108, and no, for example, in a fashion similar to arrangements 62, 64, 66, 72, 74, 76, 82, 84, and 86 described above. Permanent magnets 101, and any and all permanent magnets disclosed herein, may typically be any conventional permanent magnet, for example, a rare earth magnet as known in the art, for example, neodymium rare-earth magnets or samarium-cobalt rare-earth magnets, or their equivalent. Circular arrangements 106, 108, and no may be spaced, for example, axially spaced, at distances 112 and 114, which may be substantially the same or may vary. Though three (3) circular arrangements 106, 108, no of magnets 101 are shown in FIG. 8; however, according to aspects of the invention, core 100 may comprise one (1) or more arrangements 106 or two (2) or more arrangements 106, 108, or three (3) or more arrangements 106, 108, no of magnets 101.

As also shown in FIG. 8, as discussed previously with respect to FIG. 5, magnets in circular arrangements 106, 108, and no may be “off set” as indicated by the angle 13 in FIG. 8. Again, this offset angle 13 may limit or prevent the likelihood of magnetic “lock up” between adjacent magnets. In one aspect, the angle 13 may range from about 1 degree to about 20 degrees, for example, from about 5 degrees to about 10 degrees.

The conductors 104 in core 100 may comprise one or more electrical conductors positioned about magnets 101 as described and illustrated in FIGS. 1-7. For example, conductors 104, and any and all of the conductors disclosed herein, may comprise metallic wire, for instance, coated or uncoated metallic wire, single strand or multiple-strand metallic wire, such as, braided wire. The metallic wire of conductors 104 may typically comprise copper wire, but may also be steel, aluminum, titanium, nickel, brass, bronze, silver, or even gold wire, among other conducting materials.

Though housing 102 may comprise a transparent or a translucent material, housing 102 typically comprises an opaque material. According to aspects of the invention, housing 102 may comprise a non-ferromagnetic material, for example, a non-ferromagnetic metal, such as, an aluminum or a titanium. However, in one aspect, housing 104 also may comprise a non-electrical conducting material, for example, a plastic, rubber, a ceramic, a glass, or even wood. In one aspect, housing 102 may be fabricated from one or more of the following plastics: a polyamide (PA), for example, nylon; a polyethylene (PE); a polypropylene (PP); a polyester (PE); a polytetraflouroethylene (PTFE); an acrylonitrile butadiene styrene (ABS); a polycarbonate (PC); or a polyvinylchloride (PVC), among other plastics. In one aspect, housing 102 is preferably thermally resistant, for example, capable of withstanding temperatures of at least 100 degrees C. without deforming or otherwise losing its structural integrity. In one aspect, housing 102 may be fabricated from temperate resistant polyethylene, for example, a High Molecular Weight (HMW) polyethylene, or its equivalent.

In one aspect, the core or core element 100 shown in FIG. 8 (and any cores or core elements disclosed herein) may comprise an electrical generator core element or an electrical motor core element. In addition, the core or core element 100 shown in FIG. 8 (and any cores or core elements disclosed herein) may comprise a stator or a rotor of a generator or a motor.

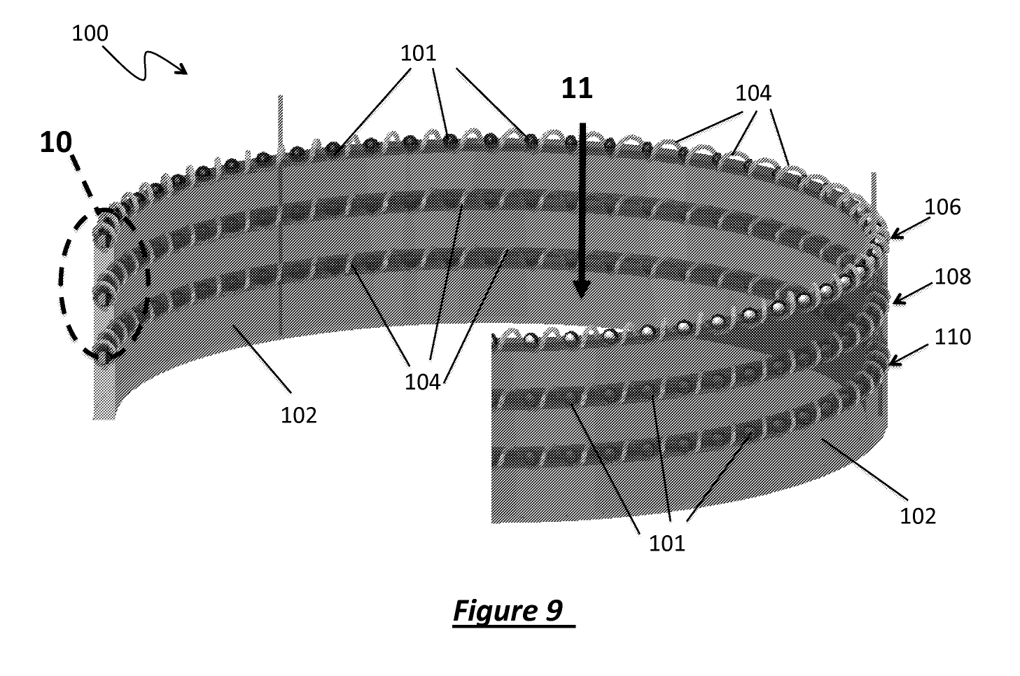

FIG. 9 is a perspective view, partially in cross section, of core 100 shown in FIG. 8. FIG. 9 identifies a typical circumferential cross section of core 100 by Detail 10 and identifies a typical axial cross section of core 100 by Detail 11.

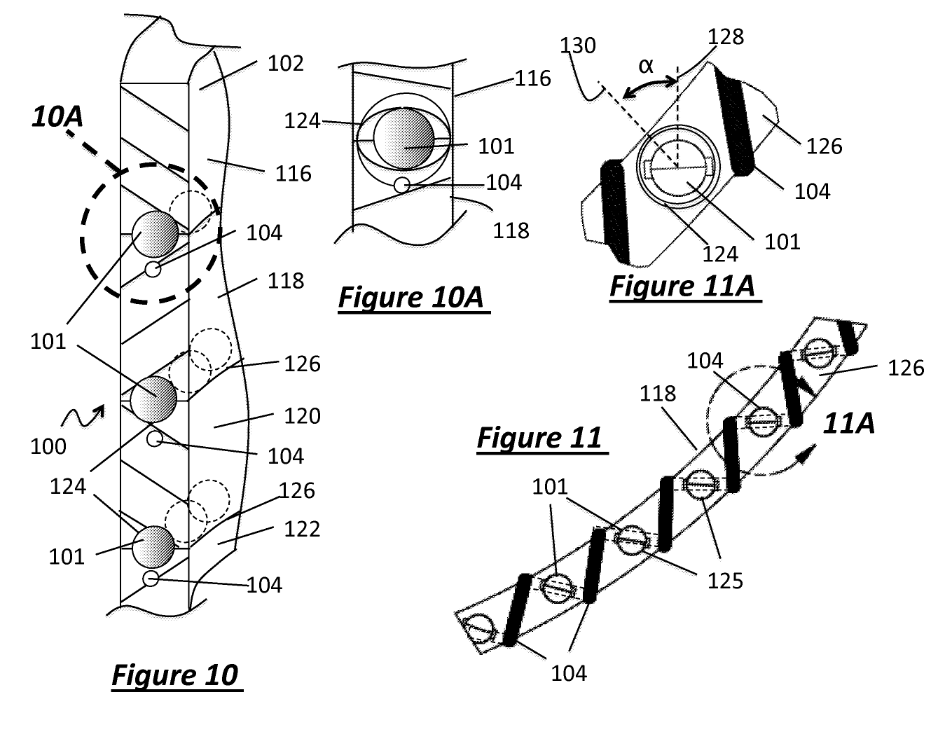

FIG. 10 is a detailed view of the circumferential cross section of the core 100 shown in FIG. 9 identified by Detail 10 in FIG. 9. FIG. 11 is a detailed view of the axial cross section of the core shown in FIG. 9 identified by Detail 11 in FIG. 9. As shown in FIG. 10, housing 102 of core 100 may comprise multiple components, rings, or spacers, for example, housing rings 116, 118, 120, and 122. Housing rings 116, 118, 120, and 122 typically contain recesses or cavities 124 adapted to retain magnets 101, for example, retain magnets 101 in a desired orientation. For example, as shown in FIG. 10 housing rings 116, 118, 120, and 122 my contain recesses 125 in mating surfaces 126, for example, semi-circular or elliptical recesses 125, that cooperate to define cavities 124 and retain magnets 101. FIG. 10A is a detailed view of the circumferential cross section of the core 100 shown in FIG. 10 identified by Detail 10A in FIG. 10 illustrating a detail of one cavity 124 that can be used to retain magnets 101 according to an aspect of the invention.

As shown most clearly in FIG. 11, housing rings 116, 118, 120, and 122 are also adapted to retain and position conductors 104, for example, in predetermined positions in housing 102. As shown in FIG. 11, in one aspect, conductors my loop about or follow a helical path about magnets 101. In one aspect conductors 104 may be inserted through cavities in housing 102 or may be molded into position in housing 102 when rings 116, 118, 120, and 122 are fabricated. As shown in FIG. 11, the conductors 104 may protrude through the external surfaces of rings 116, 118, 120, and 122; however, in one aspect, conductors 104 may not protrude from the rings, but may be encased within rings 116, 118, 120, and 122.

FIG. 11A is a detailed view of the axial cross section of the core 100 shown in FIG. 11 identified by Detail 11A in FIG. 11. FIG. 11A illustrates the detail of one cavity 124 that can be used to retain magnets 101 according to an aspect of the invention. FIG. 11A also illustrates a typical orientation of magnet 101 in housing 102 according to one aspect of the invention. As noted above in FIG. 2, according to aspects of the invention, the direction of the magnetic pole of magnets 101, represented by dashed line 128 in FIG. 11A (either the N or S pole), is directed at an angle α to the radial direction of the arrangement of magnets 101 (typically, the radial direction of the circular cylindrical housing 102), represented by dashed line 130 in FIG. 11A. In one aspect, the angle α may range from about 30 degrees to about 60 degrees, for example, from about 40 degrees to about 50 degrees. In one aspect, angle α may be about 45 degrees.

Housing rings 116, 118, 120, and 122 may be assembled into housing 102 by any conventional means, for example, by mechanical fasteners, soldering, brazing, welding, or an adhesive. In addition, magnets 101 may be retained in the recesses 126 in housing rings 116, 118, 120, and 122 by friction, by compression upon magnets 122, by an adhesive, or mechanically, for example, by means of a recess and a projection between cooperating surfaces, for example, a projection on magnets 101 and a mating recess in housing 102.

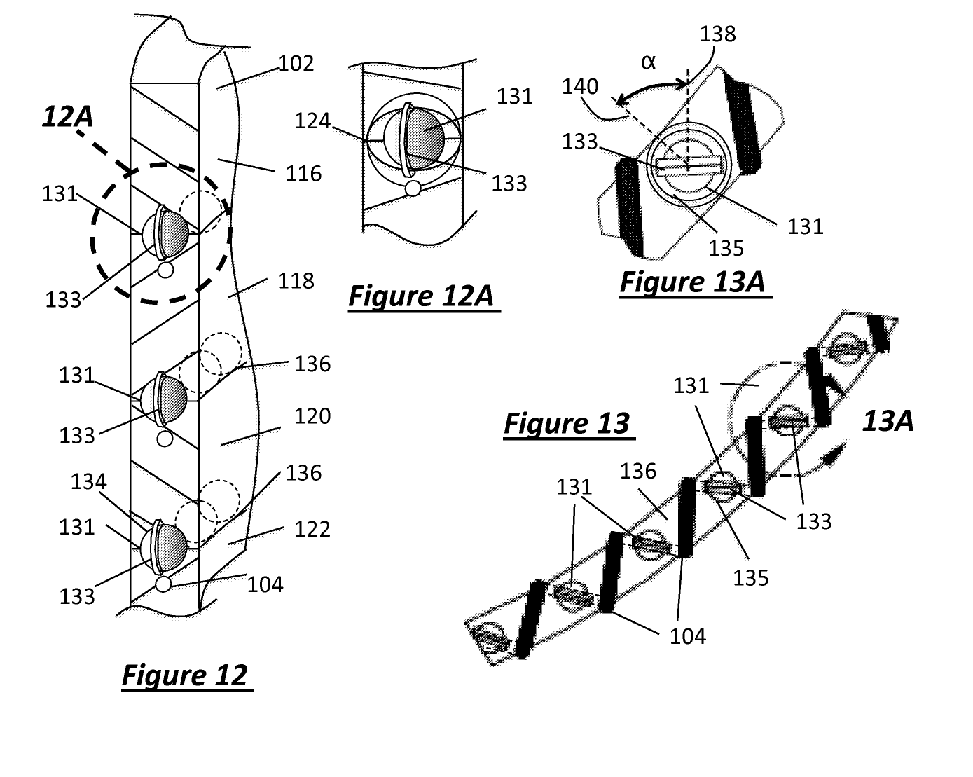

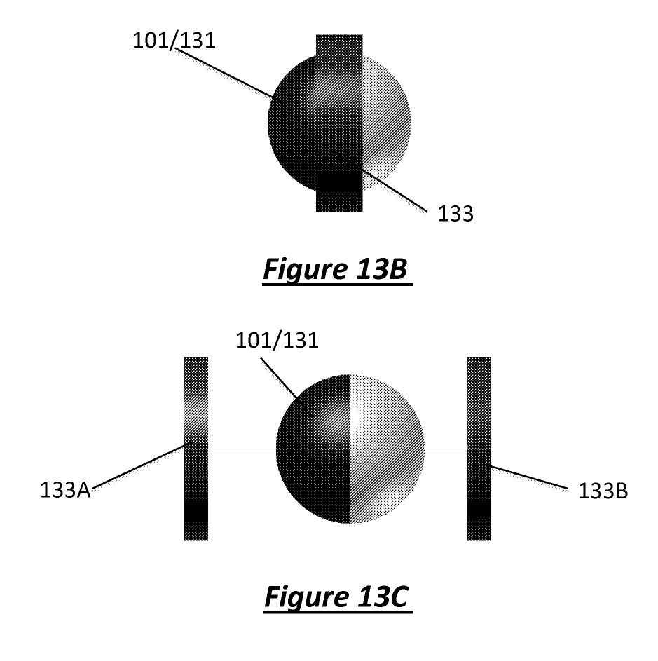

FIG. 12 is a detailed view of the circumferential cross section of the core 100 shown in FIG. 9 identified by Detail 10 in FIG. 9, similar to FIG. 10, according to another aspect of the invention. FIG. 13 is a detailed view of the axial cross section of the core 100 shown in FIG. 9 identified by Detail 11 in FIG. 9, similar to FIG. 11, according to another aspect of the invention. The aspects of the invention shown in FIGS. 12 and 13 include all the features and characteristics shown in FIGS. 10 and 11; however, the magnets 131 shown in FIGS. 12 and 13 include magnetic field concentrators, or magnetic shields, 133. In this aspect, shields 133 about magnets 131 function to collect and concentrate the magnetic flux of the magnetic field about magnets 131, for example, to enhance the current inducing effect of the relative movement of magnets 131 in adjacent cores. In one aspect, magnetic field concentrators may be made from a material having high magnetic permeability, for example, a conventional shield material.

As shown in FIG. 12, housing 102 of core 100 may comprise multiple components or ring sub-assemblies, for example, housing rings 116, 118, 120, and 122, having recesses 135 in mating surfaces 136 defining cavities 134, in a manner similar that shown and described in FIGS. 10 and 10A.

FIG. 13A is a detailed view, similar to FIG. 11A, of the axial cross section of the core 100 shown in FIG. 13 identified by Detail 13A in FIG. 13. FIG. 13A illustrates the detail of one cavity 135 that can be used to retain magnets 131 according to an aspect of the invention. FIG. 13A also illustrates a typical orientation of magnet 131 in housing 102 according to one aspect of the invention. As noted above in FIG. 2, according to aspects of the invention, the direction of the magnetic pole of magnets 131, represented by dashed line 138 in FIG. 13A (either the N or S pole), is directed at an angle α to the radial direction of the arrangement of magnets 131 (typically, the radial direction of the circular cylindrical housing 102), represented by dashed line 140 in FIG. 13A. In one aspect, the angle α may range from about 30 degrees to about 60 degrees, for example, from about 40 degrees to about 50 degrees. In one aspect, angle α may be about 45 degrees.

FIG. 13B is an elevation view of one magnet 101, shown in FIGS. 10 through 11A, and magnet 131, shown in FIGS. 12 through 13A, having a magnetic field concentrator 133 according to aspects of the invention. FIG. 13C is an exploded view of the magnet 101/131 shown in FIG. 13B. As shown in FIGS. 13B and 13C, in one aspect, magnets 101 and 131 may comprise spherical magnets, for example, having opposing poles (N and S) identified by the difference in shading shown. It is understood that spherical magnets provide a magnetic field that may be optimally suited for aspects of the invention, for example, by providing a more uniform magnetic field. However, magnets 101 and 131 may take other shapes while still providing an effective magnetic field. For example, magnets 101 and 131 (and any other magnets disclosed herein) may be cylindrical in shape, for example, circular, oval, or polygonal cylindrical in shape, including triangular, square, rectangular, and pentagonal cylindrical in shape, among other cylindrical shapes. Magnets 101 and 131 (and any other magnets disclosed herein) may comprise any type of permanent magnet. In one aspect, magnets 101 and 131 (and any other magnets disclosed herein) may comprise a rare-earth permanent magnet as disclosed herein, for example, neodymium rare-earth magnets or samarium-cobalt rare-earth magnets, or their equivalent. Magnets 101 and 131 (and any other magnets disclosed herein) may be from about 0.25 to about 2 inches in diameter, but may typically be about 0.25 to about 0.5 inches in diameter, for example, about 0.375 inches in diameter.

The magnetic field concentrator or shield 133 may also comprise any suitable shape depending upon the shape of magnets 101 and 131. In the aspect shown in FIGS. 13B and 13C, concentrators 133 comprise two substantially identical halves 133A and 133B which provide a circular cylindrical profile while conforming to the external shape of magnet 101/131. For example, as shown, concentrators 133 may provide a circular cylindrical outer surface and a hemispherical or dished depression conducive to the spherical shape of magnet 101/131. It will be apparent to those of skill in the art that the shape of concentrators 133 may accordingly vary broadly.

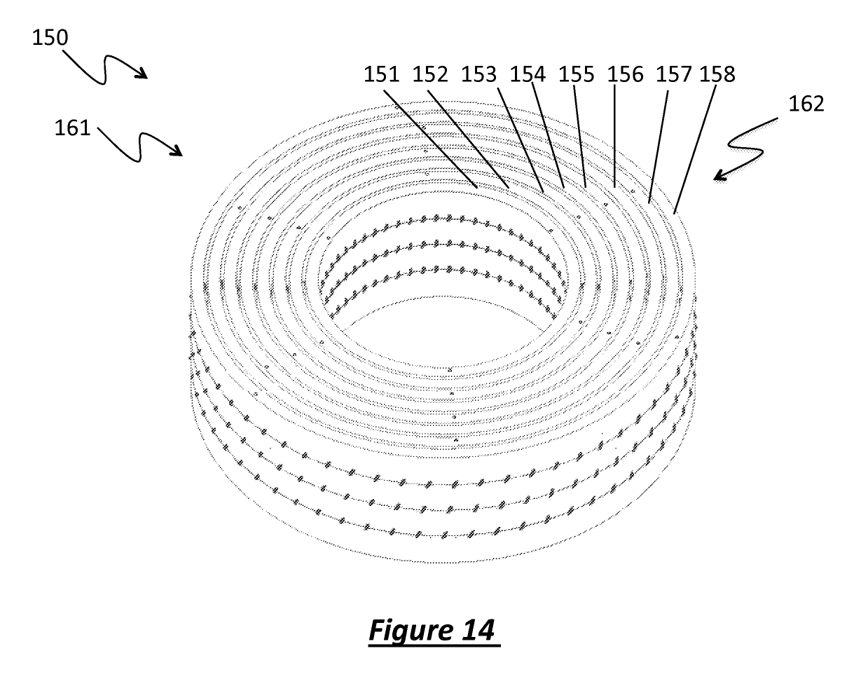

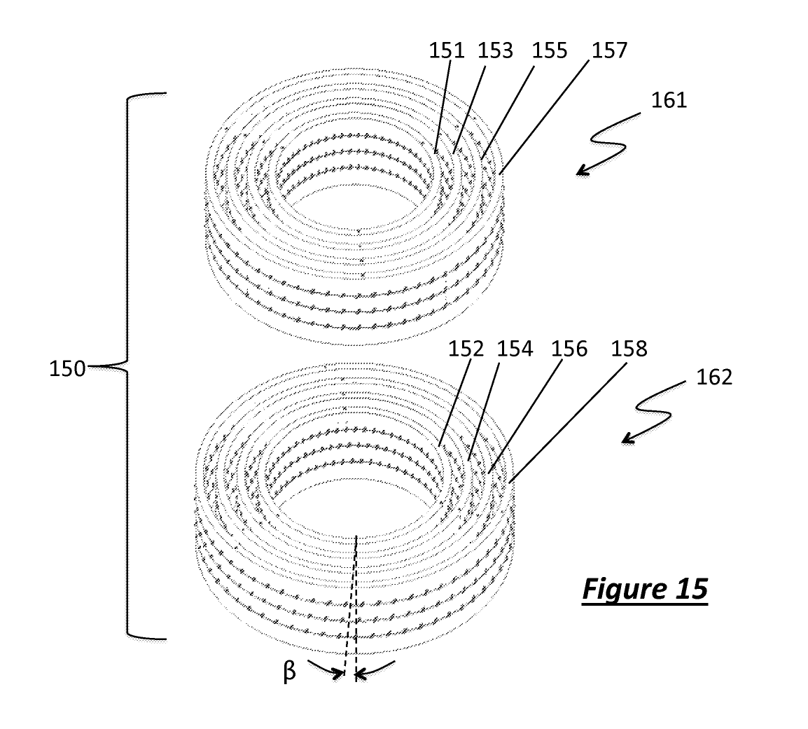

FIG. 14 is a perspective view of a core or ring assembly 150 of multiple cores or rings 151, 152, 153, 154, 155, 156, 157 and 158 according to one aspect of the invention. Cores 151-158 each typically include magnets 101/131 and conductors 104 (not shown) similar to core 100 and its sub-assemblies shown in FIGS. 8 through 13B, inclusive. According to aspects of the invention, cores 151-158 comprise two sets of cores, an upper or top core rack 161 and a lower or bottom core rack 162, the two sets of core racks 161 and 162 are shown engaged in FIG. 14. The upper core rack 161 includes individual cores 151, 153, 155, and 157; the lower core rack 162 includes individual cores 152, 154, 156, and 158. FIG. 15 is an exploded perspective view of the core assembly 150 shown in FIG. 14 in which upper core rack 161 and a lower core rack 162 are shown separated. Though eight (8) cores having two racks of four (4) cores each are shown in FIG. 14 for illustrative purposes, according to aspects of the invention, assembly 150 may include two (2) or more cores, and each rack 161 and 162 may contain one (1) or more cores. However, in one aspect, core assembly 150 may typically include four (4) or more cores, and each rack 161 and 162 may include two (2) or more cores each. In addition, core assembly 150 may typically include more than eight (8), for example, ten (10) or more cores or twelve (12) or more cores, and each core rack 161 and 162 may each include five (5) or more cores or six (6) or more cores. In one aspect, the number of rings or cores in assembly 150 may only be limited by the space available to accommodate the cores.

According to aspects of the invention, the two core racks 161 and 162 may be selectively engaged, for example, axially engaged, from positions shown in FIG. 15 to the positions shows in FIG. 14 wherein the magnetic fields of adjacent magnets 101/131 in adjacent cores of the two core racks 161 and 162 influence each other and generate a tangential acceleration, for example, as illustrated in FIG. 2. For example, according to aspects of the invention, the individual cores 151, 153, 155, and 157 of upper core rack 161 are positioned and displaced with respect to the individual cores 152, 154, 156, and 158 of lower core rack 162 wherein individual cores 151, 153, 155, and 157 are moved into the radial spaces between individual cores 152, 154, 156, and 158 where at least some of the magnets 101/131 in upper core rack 161 are influenced by at least some of the magnets 101/131 in lower core rack 162 to provide at least some circumferential loading to at least some of the cores in upper core rack 161 and at least some circumferential loading to at least some of the cores in lower core rack 162. In one aspect, substantially all of the magnets 101/131 in upper core rack 161 are influenced by substantially all the magnets 101/131 in lower core rack 162 to provide at least some circumferential loading to at least some of the cores in upper core rack 161 and at least some circumferential loading to at least some of the cores in lower core rack 162. As shown and described above with respect to FIG. 2, according do aspects of the invention, the circumferential loading and circumferential movement of the magnets 101/131 in the cores in upper core rack 161 and in the cores of lower core rack 162 induces electrical currents within the conductors 104 in at least some of the cores in the upper core rack 161 and in the cores of lower rack 162. This electrical current induced by the relative motion of magnets 101/131 can be extracted from assembly 150 to provide a source of electric power.

As also shown in FIG. 15, as discussed previously with respect to FIGS. 5 and 8, magnets in circular arrangements in upper core rack 161 and/or in lower core rack 162 may be “off set” as indicated by the angle β in FIG. 15. Again, this offset angle 13 may limit or prevent the likelihood of magnetic “lock up” between adjacent magnets. In one aspect, the angle β may range from about 1 degree to about 20 degrees, for example, from about 5 degrees to about 10 degrees. In one aspect of the invention, magnets in only one core rack 161 or 162 may be offset by an angle β. For example, as shown in FIG. 15, in one aspect, substantially all the magnets in lower core rack 162 may be offset by an angle β while the substantially all the magnets in upper core rack 161 may not be offset, but may be substantially collinear with magnets in adjacent elevations within the cores.

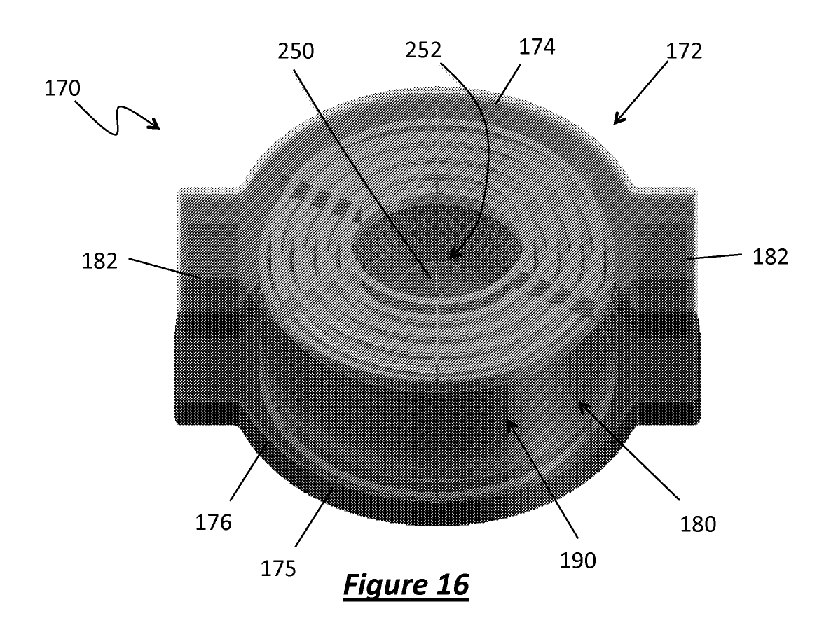

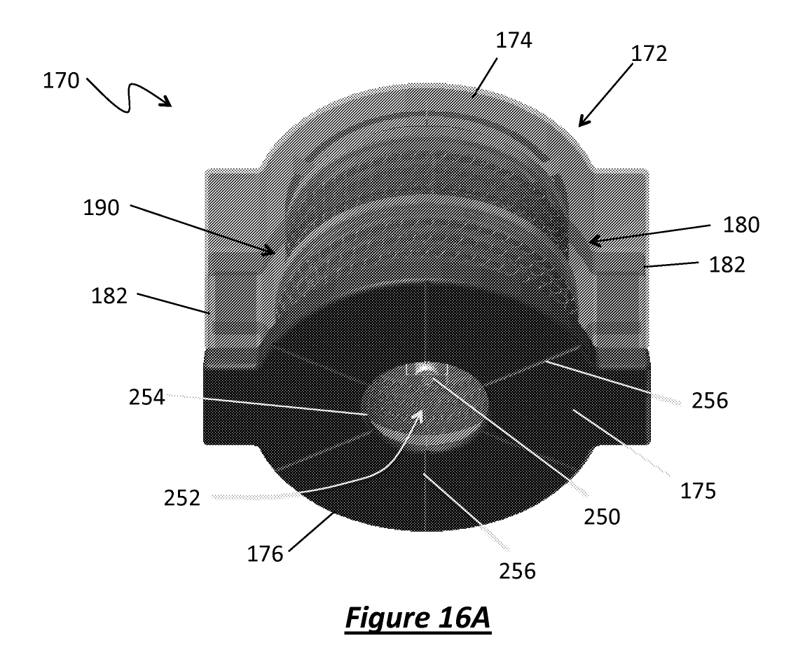

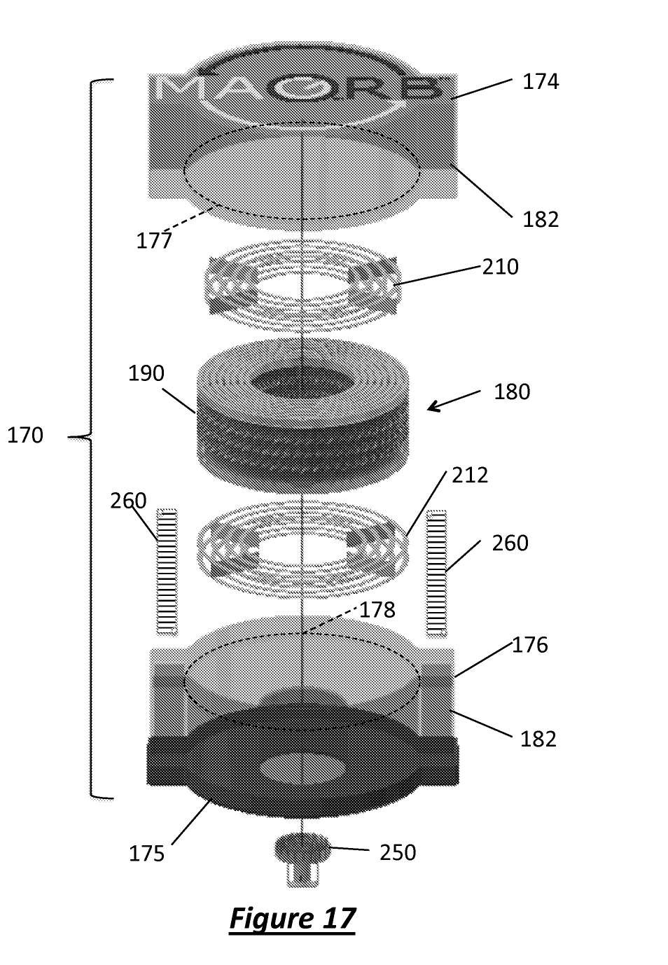

FIG. 16 is a top perspective view of an electric generator 170 encompassing aspects of the present invention, having the core assembly 190 in an “engaged” position. FIG. 16A is a bottom perspective view of the electric generator 170 shown in FIG. 16, having the core assembly 190 in an “unengaged” position. FIG. 17 is an exploded perspective view of the generator 170 shown in FIGS. 16 and 16A. As shown in FIG. 16, generator 170 includes a housing 172 comprising a top enclosure 174 and a bottom enclosure 176 containing a bearing and core assembly 180. In FIG. 16, top enclosure 174 and a bottom enclosure 176 are shown translucent so that the bearing and core assembly 180 along with other components can be seen within housing 172. As shown in FIGS. 16 and 16A, bottom enclosure 176 may include a resilient base 175, for example, an elastomeric or rubber base adapted to rest upon a surface (not shown) and cushion and/or isolate generator 170 from the surface. According to aspects of the invention, bearing and core assembly 180 may typically include a core assembly 190, for example, similar to core assembly 150 shown in FIGS. 14 and 15, though the number and size of individual cores in core assembly 190 may vary from core assembly 150 may vary.

In the aspect shown in FIGS. 16, 16A, and 17 housing 172 is shown generally circular cylindrical in shape to comply with the generally circular cylindrical shape and/or size of bearing and core assembly 180; however, housing 172 may take any appropriate shape regardless of the shape and size of core bearing and core assembly 180. For example, in one aspect, as shown in FIGS. 16, 16A, and 17, housing 172 may include one or more cavities or chambers 182 adapted to housing ancillary equipment, parts, and/or supplies. For example, in one aspect, chambers 182 may be provided to house electronics adapted to operate, control, and/or monitor the operation of generator 170, for instance, any related electronics (for example, capacitors), controls, electric storage devices (for example, batteries), and related devices or equipment.

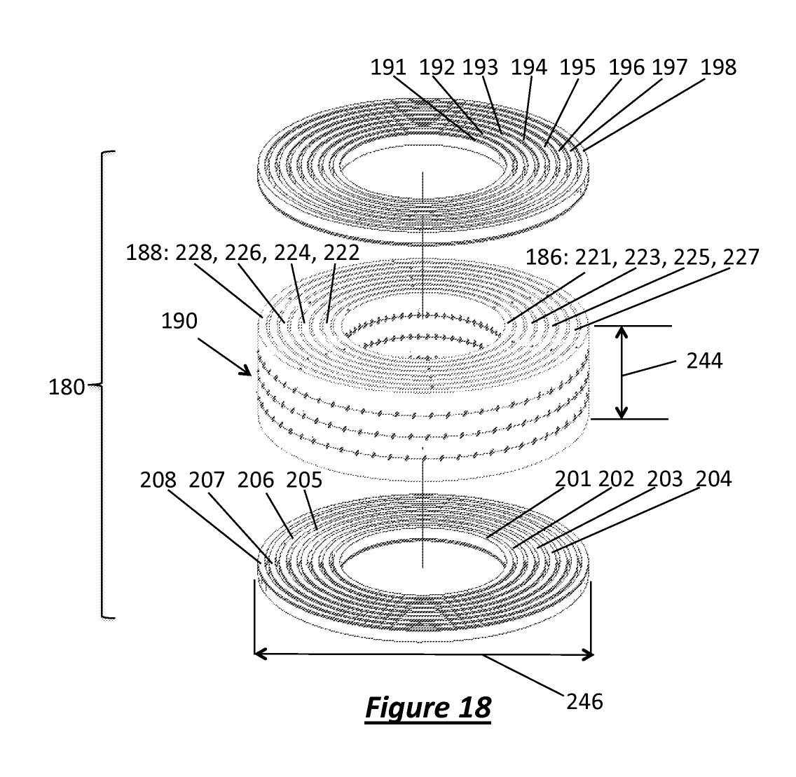

As shown most clearly in FIG. 17, according to aspects of the invention, bearing and core assembly 180 includes core assembly 190 and a plurality of uppers bearings 191, 192, 193, 194, 195, 196, 197, 198 and a plurality of lower bearings 201, 202, 203, 204, 205, 206, 207, and 208 associated with each of the individual cores in core assembly 190. (For example, with each of the cores 151-158 of core assembly 150 shown in FIG. 15.) FIG. 18 is an exploded perspective view of the bearing and core assembly 180 shown in FIG. 17.

As shown in FIG. 18, bearing and core assembly 180 typically includes a core assembly 190, an upper core rack 186, upper bearings 191-198, a lower core rack 188, and lower core bearings 201-208. Similar to core assembly 150 shown in FIGS. 14 and 15, core assembly 190 in FIG. 18 typically includes an upper core rack 186 having cores 221, 223, 225, and 227, and a lower core rack 188 having cores 222, 224, 226, and 228. In the aspect shown in FIG. 18, upper core rack 186 is shown engaged with lower core rack 188.

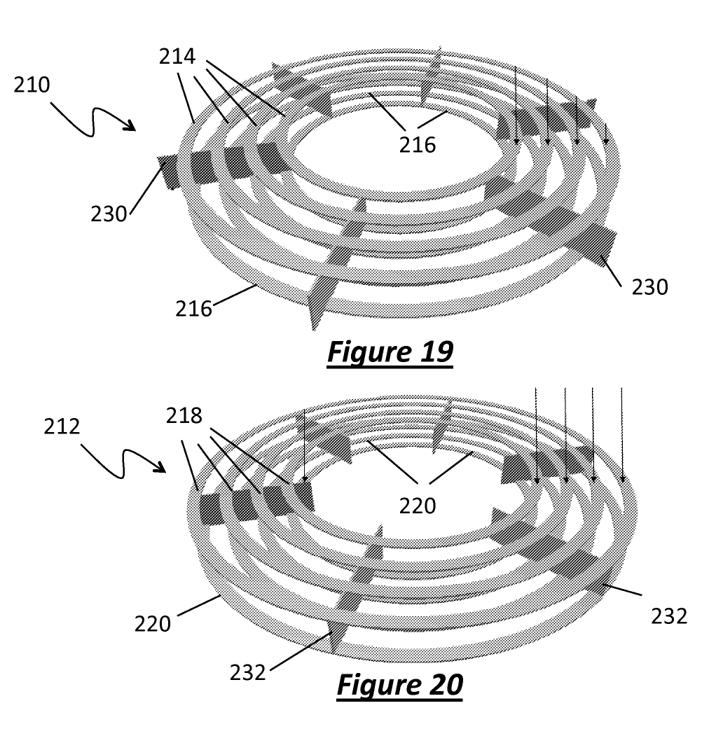

As also shown in FIG. 17, generator 170 includes and upper or top bearing rack 210 and a lower or bottom bearing rack 212. According to aspects of the invention, bearing racks 210 and 212 are positioned and adapted to provide a pathway for current generated in bearing and core assembly 180 and also to provide positioning and support of bearing and core assembly 180 within housing 172. For example, in one aspect, top bearing rack 210 engages top enclosure 174, for example, rigidly or fixedly engages top enclosure 174, and bottom bearing rack 212 engages bottom enclosure 176, for example, rigidly or fixedly engages bottom enclosure 176. In one aspect, bottom bearing rack 212 is electrically coupled to bottom enclosure 176 and both may be grounded by a common ground. (Though, in another aspect, top bearing rack 210 may be electrically coupled to top enclosure 174 and both may be grounded by a common ground.) According to aspects of the invention, any structure adapted to provide the dual function of current carrying and positioning may be used for top bearing rack 210 and bottom bearing rack 212. However, in one aspect of the invention, top bearing rack 210 and bottom bearing rack 212 may take the form of the bearing racks 210 and 212 shown in FIGS. 19 and 20.

FIG. 19 is a perspective view of one top bearing rack 210 and FIG. 20 is a perspective view of one bottom bearing rack 212 that may be used in generator 170 according to aspects of the invention. As shown in FIG. 19, top bearing rack 210 includes a plurality of circular top rings 214, which, as shown in FIGS. 16 and 17, are adapted to engage top enclosure 174. Top bearing rack 210 also includes a plurality of circular bottom rings 216 adapted to engage the upper bearings 192, 194, 196, and 198 of the upper core rack 186 of bearing and core assembly 180. Similarly, as shown in FIG. 20, bottom bearing rack 212 includes a plurality of circular top rings 218, which, as shown in FIGS. 16 and 17, are adapted to engage the lower bearings 201, 203, 205, and 207 of lower core rack 188 of bearing and core assembly 180. Bottom bearing rack 212 also includes a plurality of bottom rings 220 adapted to engage bottom enclosure 176.

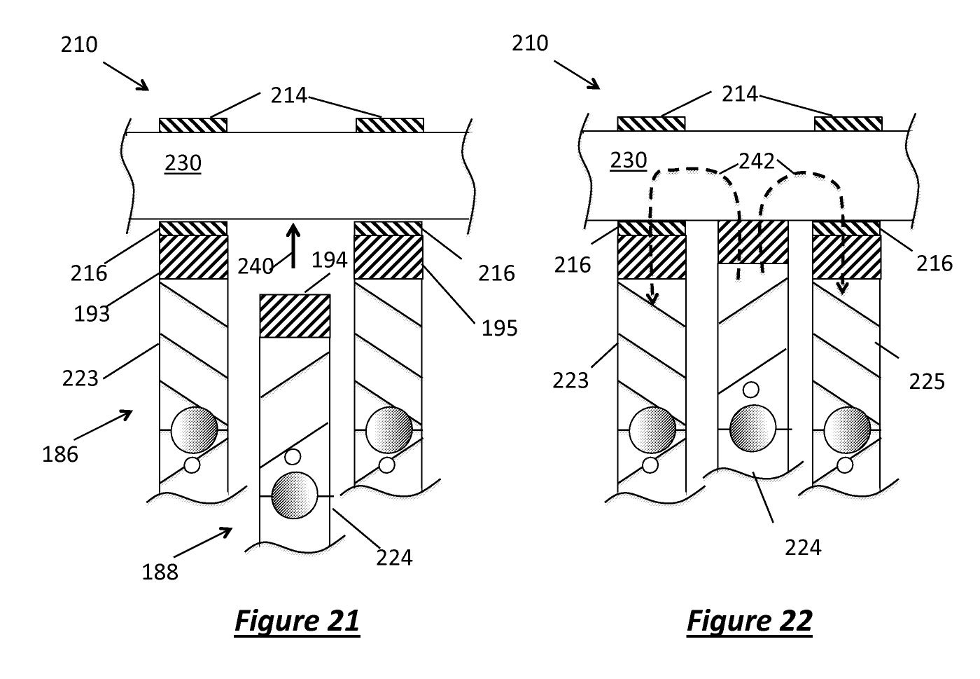

As also shown in FIGS. 19 and 20, top bearing rack 210 includes a plurality of tabs or plates 230 between upper rings 214 and lower rings 216, and bottom bearing rack 212 includes a plurality of tabs or plates 232 between upper rings 218 and lower rings 220. According to aspects of the invention, in addition to providing at least some structural integrity to the top bearing rack 210 and the bottom bearing rack 212, plates 230 and 232 also function to provide a current path between adjacent cores in the upper core rack 186 and the lower core rack 188 of core assembly 190. This is illustrated most clearly in FIGS. 21 and 22.

FIG. 21 is a cross sectional view of a portion of a typical rack core assembly 180 and top bearing rack 210, prior to complete engagement of lower core rack 188 with top core rack 186, according to one aspect of the invention. In the aspect shown in FIG. 21 (and FIG. 22), for the sake of illustration, only a portion of cores 223, 224, and 225 of rack core assembly 180 and only a portion of top bearing rack 210 are shown; however, this feature of the invention is common to other cores 221-228 and other portions both the top bearing rack 210 and of the bottom bearing rack 212.

FIG. 21 shows cross sections of a portion of top bearing rack 210 and cross sections of portions core 223 (having bearing 193) and core 225 (having bearing 195) of upper core rack 186 and a cross section of a portion core 224 (having bearing 194) of lower core rack 188. As shown, the portion of top bearing rack 210 includes upper rings 214, lower rings 216, and plates 230. As represented in FIG. 21, lower core rack 188 is not yet fully engaged with upper core rack 186. According to aspects of the invention, the relative axial engagement lower rack 188 and upper core rack 186, as indicted by arrow 240 (though upper core rack 186 may also move relative to lower core rack 188), results in the impingement of bearing 194 of lower core 224 with one or more plates 230 of top bearing rack 210. This engagement is illustrated in FIG. 22.

FIG. 22 is a cross sectional view, similar to FIG. 21, of a portion of a typical rack core assembly 180 and top bearing rack 210, after engagement of lower core rack 188 with top bearing rack 210, according to one aspect of the invention. As shown in FIG. 22, after engagement, at least bearing 194 of lower core rack 188 impinges one or more plates 230 of top bearing rack 210. However, typically, substantially all bearings 192, 194, 196, and 198 of lower cores 222, 224, 226, and 228 impinge and/or contact the multiple plates 230 of top bearing rack 210. As a result, since the components shown in FIGS. 21 and 22 are typically electrically conductive, the engagement of lower core rack 224 with top bearing rack 210 creates a pathway for current between the lower core rack 188 and the upper core rack 186, as indicated by dashed arrows 242 (though electric current may flow in the opposite direction to the direction of arrows 242).

Though only a portion of a typical rack core assembly 180 and top bearing rack 210, after engagement of lower core rack 188 with top bearing rack 210, is shown in FIG. 22, the engagement shown in FIGS. 21 and 22 is typical of the engagement of any and all cores of upper core rack 186 and lower core rack 188 disclosed herein. In addition, though, again, not shown in FIGS. 21 and 22, this engagement of lower core rack 188 and upper core rack 186 is also typical of the engagement of the lower bearings of 202, 204, 206, and 208 of the cores of lower core rack 188 with rings 218 of bottom bearing rack 212. That is, according to aspects of the invention, with the engagement shown in FIGS. 21 and 22, after engagement, at least one bearing 202, 204, 206, and 208 of lower core rack 188 impinges one or more plates 232 of bottom bearing rack 212. However, typically, substantially all bearings 202, 204, 206, and 208 of lower cores 222, 224, 226, and 228 impinge and/or contact the multiple plates 232 of bottom bearing rack 212. As a result, a current path is also provided between the cores of upper core rack 186, lower core rack 188, and bottom bearing rack 212.

Accordingly, top bearing rack 210 and bottom bearing rack 212 may at least partially be conductive. For example, in one aspect, all the components of top bearing rack 210 and bottom bearing rack 212 may be electrically conductive. Top bearing rack 210 and bottom bearing rack 212 may typically be made from copper, though any one or more the conductive materials disclosed herein may be used.

Returning to FIG. 18, as noted, bearing core assembly 190 may comprise a range of cores, for example, four (4) or more cores or twelve (12) or more cores. In the aspect shown in FIG. 18, upper core rack 186 and lower core rack 188 are engaged, and, according to aspects of the invention, the interaction of magnets 101/131 in the respective cores causes the rotation of cores and the generation of electric current. According to aspects of the invention, the number of cores may directly indicate the amount of electrical power (or current) generated by aspects of the invention. As shown in FIG. 18, core assembly 190 may have a height 244 ranging from about 3 inches to about 6 feet, but aspects of the invention may typically have a height 224 from about 6 inches to about 24 inches, for example, about 9 inches in height. Also, core assembly 190 may have an outer diameter 246 ranging from about 3 inches to about 6 feet, but aspects of the invention may typically have a diameter 246 from about 1 foot to about 3 feet, for example, about 2 feet in diameter.

As described herein, according to aspects of the invention, the interaction of magnets 101/131 in the respective cores causes the rotation of cores and the generation of electric current. As shown with respect to FIGS. 14, 15 and 18, the interaction of magnets 101/131 is effected by engaging the cores of upper core rack 161, 186 with the cores of lower core rack 162, 188. According to aspects of the invention, upper core rack 161, 186 may be selectively engaged to generate the desired electrical current. According to aspects of the invention, this selective engagement of upper core rack 186 with lower core rack 188 may be effected by any conventional means, for example, any means for translating or moving core racks 186 and 188 relative to each other to effect the desired proximity of magnets 101/131. Several means of effecting the desired engagement may be illustrated with respect to FIGS. 16, 16A, and 17.

As shown and described with respect to FIGS. 16, 16A, and 17, generator 170 includes bearing and core rack assembly 180 enclosed within housing 172, which includes top enclosure 174 and bottom enclosure 176. According to one aspect, top enclosure 174 and bottom enclosure 176 may be translatable relative to each other, and the relative translation of top enclosure 174 and bottom enclosure 176 may be employed to effect the relative translation of upper core rack 186 and lower core rack 188. For example, as disclosed with respect to FIGS. 19 and 20, top bearing rack 210 may be mounted in top enclosure 174 and bottom bearing rack 212 may be mounted in bottom enclosure 176. As described above, top bearing rack 210 may typically engage the cores of upper core rack 186 and bottom bearing rack 212 may typically engage the cores of lower core rack 188. Therefore, according to one aspect of the invention, top enclosure 174 and bottom enclosure 176 may be translated, for example, axial translated, relative to each other to provide the desired relative engagement of upper core rack 186 and lower core rack 188.

In one aspect, any conventional means may be provided to yield a desired relative translation of top enclosure 174 and bottom enclosure 176. For example, in one aspect, the relative movement or translation of top enclosure 174 and bottom enclosure 176 may be effective by mechanical means, for example, by means of automated actuators, for example, employing gears, pulleys, sheaves, bearings, pistons, and the like. However, according to one aspect of the invention, the desired translation of top enclosure 174 and bottom enclosure 176 to effect the desired translation of upper core rack 186 and lower core rack 188 may be provided by means of vacuum.

For example, with respect to FIGS. 16 and 17, in one aspect, housing 172 may be a substantially air-tight housing whereby the translation of top enclosure 174 and bottom enclosure 176 may be provided by introducing a sub-atmospheric pressure within housing 172 whereby top enclosure 174 and bottom enclosure 176 are drawn together under the influence of the prevailing atmospheric pressure. In one aspect, the influence of atmospheric pressure upon the relative movement of top enclosure 174 and bottom enclosure 176 may be opposed or resisted by a resilient device, for example, a spring or an elastomeric device.

In one aspect, any means may be provided for introducing a sub-atmospheric pressure (for example, a vacuum) within housing 172. In one aspect, a source of sub-atmospheric pressure may be provided by one or more external sources, for example, one or more external vacuum pumps. However, in one aspect, as shown in FIG. 17, one or more internal vacuum pumps 250 may be positioned within enclosure 172. Vacuum pump 250 may be provided anywhere within enclosure 250, for example, within the chambers 182. In the aspect shown in FIGS. 16, 16A, and 17, a vacuum pump 250 is positioned in a centrally located pump chamber 252 within enclosure 172. Vacuum pump 250 may be any conventional vacuum pump.

According to one aspect, in addition to providing a means for relatively deflecting top enclosure 174 and/or bottom enclosure 176, the presence of a vacuum in enclosure 172 may advantageously reduce the air resistance to rotation of the cores in core assembly 190.

According to one aspect of the invention, the inlet of vacuum pump 250 may be exposed to the inside of enclosure 172 and the outlet of vacuum pump 250 may be discharged out of enclosure 172, for example, through any appropriately located outlet or port in enclosure 172. In one aspect, the outlet of vacuum pump 250 may be directed to one or more discharge holes or air holes 254, for example, centrally located holes, in the bottom enclosure 176. In addition, or order to aid the flow of air from out of hole 254, when enclosure 172 is positioned on a surface (not shown), as shown in FIG. 16A, bottom enclosure 176 may include one or more elongated recesses, channels, or grooves 256 in the bottom of bottom enclosure 176 to provide one or more paths for the air discharged by vacuum pump 250 out of discharge hole 254.

In one aspect, in order to maintain the sub-atmospheric pressure within enclosure 172 while permitting relative translation of top enclosure 174 and bottom enclosure 176, some form of gas-sealing device (not shown) may be provided between top enclosure 174 and bottom enclosure 176. For example, in one aspect, a relatively air-tight seal (not shown) may be provided between the mating surfaces of top enclosure 174 and bottom enclosure 176, for example, an appropriate elastomeric seal, such as, as wiper-type seal. In one aspect, the seal may be a lubricated seal, for example, a self-lubricated rubber skin seal. In one aspect, the seal may be located on an inner surface or outer surface of the of top enclosure 174 and/or bottom enclosure 176 depending upon the relative positions and relative geometry of the mating surfaces of top enclosure 174 and bottom enclosure 176.

As noted above, in one aspect of the invention, generator 170 may include some form of device that resists the relative translation of top enclosure 174 and bottom enclosure 176, for example, under the influence of atmospheric pressure. For example, as shown in FIG. 17, generator 170 may include one or more springs or elastomeric materials 260 adapted to resist the collapsing movement top enclosure 174 and bottom enclosure 176, and, for example, return top enclosure 174 and bottom enclosure 176 (and their respective cores) to an unengaged position when the vacuum is removed.

In one aspect of the invention, the movement or disengagement of top enclosure 174 and bottom enclosure 176 may be limited, for example, to prevent the undesirable total disengagement of top enclosure 174 from bottom enclosure 176. In one aspect, this disengagement may be prevented by one or more mechanical stops or lips that prevent the complete disengagement of top enclosure 174 from bottom enclosure 176. According to another aspect of the invention, the disengagement of top enclosure 174 and bottom enclosure 176 may be prevented by the use of magnets, for example, by the use cooperating magnets 177, 178 mounted on the top enclosure 174 and the bottom enclosure 176, respectively, referred to as “rim magnets,” having opposite polarity that engage and minimize or prevent the disengagement of top enclosure 174 and the bottom enclosure 176.

The operation of generator 170 according to aspects of the invention is illustrated with respect to FIGS. 16 through 18. As shown most clearly in FIGS. 16 and 16A, prior to operation of activation of generator 170, top enclosure 174 and bottom enclosure 176 are separated or displaced whereby the upper core rack 186 and the lower core rack 188 (see, for example, FIGS. 15, 16A, and 18) are disengaged whereby the magnets 101/131 in core racks 186 and 188 are substantially not magnetically influenced by each other. In this discussion, it is assumed that generator 170 rests on a surface [not shown] whereby the bottom of bottom enclosure 176 is stationary and rests on the surface, and top enclosure 174 is substantially free to translate relative to stationary bottom enclosure 176. (In one aspect, bottom enclosure 176 may be free to translate relative to a stationary top enclosure 174, or both the top enclosure 174 and bottom enclosure 176 may be unrestrained and translatable.) As discussed, the relative positions of top enclosure 174 and bottom enclosure 176 may be influenced by the presence of one or more coil springs 26o between top enclosure 174 and bottom enclosure 176.

With initiation of engagement, for example, by means of the electronics and controls located in chambers 182 or by an human operator, the relative translation of top enclosure 174 and bottom enclosure 176 may be effected by the activation of vacuum pump 250 and the discharge of air from enclosure 172, for example, via air hole 254 and channels 256. The vacuum in enclosure 172 may be maintained by controlling the operation of vacuum pump 250 and/or by closing a valve, for example, a valve positioned between vacuum pump 250 and air hole 254, to isolate the inside of enclosure 172 and maintain the desired vacuum. With the introduction of vacuum within enclosure 172 and the presence of a substantially air-tight seals between the top enclosure 174 and the bottom enclosure 176, under the influence of prevailing pressure, in this aspect, top enclosure 174 translates downward toward the stationary bottom enclosure 176. With the translation of top enclosure 174, top bearing rack 186 with cores 221, 223, 225, and 227 also translates (in this case downward) into engagement with cores 222, 224, 226, and 228 of lower core rack 188.

According to aspects of the invention, as the magnets 101/131 of the cores of top core rack 186 begin to influence the magnets in lower core rack 188, under the influence of the repulsion of like poles in magnets 101/131, at least some of the cores in the upper core rack 186 and the cores in the lower core 188 begin to rotate within core assembly 190. That is, according to one aspect of the invention, generator 170 may “self-start” by engaging top core rack 186 with lower core rack 188. The speed of rotation of the cores in upper core rack 186 and lower core rack 188 may increase to at least 100 rotations per minute [rpm], but typically ranges from about 500 rpm to about 2500 rpm, or more. In one aspect, the speed of cores may be limited by bearings 191-198 and/or 201-208, for example, by friction between the bearings and the bearing racks 210, 212. This relative rotation of cores is assisted by the axial offset of magnets 101/131 (see angle β in FIGS. 5 and 8) which minimizes or prevents the likelihood of “lock up” between adjacent cores. As discussed most clearly with respect to FIG. 2, with the relative movement of magnets 101/131 and the presence of conductors 104 about magnets 101/131, an electric current is induced in conductors 104. This electric current passes through conductors 104 and is carried to, for example, upper bearings 191-198 and then, as illustrated in FIGS. 21 and 22 from the upper bearings 191-198 through top bearing rack 210 and to an external load, for example, to power a motor, or to storage, for example, to one or more batteries. In addition, in one aspect, the electric current generated may be directed back into generator 170 in order to further increase the speed of rotation of one or more cores in core assembly 190.

According to one aspect of the invention, all cores in upper core rack 186 and lower core rack 188 may rotate. However, in another aspect, all cores in upper core rack 186 and lower core rack 188 except the outermost core in lower core rack 188 may rotate. That is, in one aspect, the outermost core in lower core rack 188, that is, core 158 in FIGS. 14 and 15 or core 228 in FIG. 18, may be stationary or may not rotate. In addition, according to aspects of the invention, due to the relative geometry of the cores in rack cores 186 and 188, the speed of rotation of cores may vary. For example, in one aspect, the speed of rotation may increase in each core from the outer-most core 228 to the inner most core 221.

After sufficient activation and electrical energy generation, generator 170 may be deactivated by disengaging upper core rack 186 from lower core rack, for example, by deactivating vacuum pump 250 and allowing top enclosure 174 to disengage from lower enclosure 176, for example, under the influence of one or more springs 260, whereby the magnets 101/131 in respective cores are substantially displaced from each other whereby little or no relative translation of cores occurs. In addition, in one aspect, shown most clearly in FIG. 21, with the disengagement of upper core rack 186 from lower core rack 188, the juxtaposition of opposite magnetic poles in adjacent disengaged cores may result in attraction between the opposite magnetic stops and retardation of any relative movement between cores. For example, in one aspect, the disengagement of upper core rack 186 from lower core rack 188 may initiate a braking action and retard or terminate the rotation of cores in both the upper rack 186 and the lower core rack 188.

Accordingly, the presented aspects of the invention provide permanent-magnet electric generators and methods of generating electrical energy that overcome the limitations of the existing art. Aspects of the invention may be used to generate electricity for a broad range of applications, indeed any application requiring a source of electric power. The applications of the present invention may be used, but are not limited to, vehicles, robots, and mobile devices, among many others. As will be appreciated by those skilled in the art, features, characteristics, and/or advantages of the various aspects described herein, may be applied and/or extended to any embodiment (for example, applied and/or extended to any portion thereof).

While several aspects of the present invention have been described and depicted herein, alternative aspects may be effected by those skilled in the art to accomplish the same objectives. Accordingly, it is intended by the appended claims to cover all such alternative aspects as fall within the true spirit and scope of the invention.

1-20. (canceled)

21. An electrical core element for generator, the core element comprising:
at least one circular arrangement of permanent magnets;
a plurality of electrical conductors passing in proximity with at least some of the permanent magnets; and
a housing adapted to retain each of the permanent magnets in the arrangement of permanent magnets in a predetermined orientation and adapted to retain the plurality of electric conductors in a predetermined position.

22. The core element as recited in claim 21, wherein the predetermined orientation comprises orienting a pole of each of the permanent magnets radially within the at least one circular arrangement.

23. The core element as recited in claim 21, wherein the at least one circular arrangement of permanent magnets comprises a plurality of spaced circular arrangements of permanent magnets.

24. The core element as recited in claim 23, wherein the plurality of spaced circular arrangements of permanent magnets comprises a plurality of axially spaced circular arrangements of permanent magnets.

25. The core element as recited in claim 21, wherein the at least one circular arrangement of permanent magnets comprises at least one circular arrangement of permanent rare-earth magnets.
